(19) United States
(12) Patent Application Publication
(10) Pub. No.: US 2012/0037088 A1
(43) Pub. Date: Feb. 16, 2012

(54) MINIATURE REMOTE GPS RECOVERY SYSTEM

(76) Inventor: Rebecca Leah Altenhofen, Glendale, AZ (US)

(21) Appl. No.: 13/030,560

(22) Filed: Feb. 18, 2011

Related U.S. Application Data
(60) Provisional application No. 61/338,743, filed on Feb. 24, 2010.

(51) Int. Cl. G01S 19/14; A01K 15/02; G01S 19/29

(52) U.S. Cl. 119/720; 342/357.51

(57) ABSTRACT

A GPS module, normally in an inactive mode and switchable to an active mode, receives signals in the active mode from GPS satellites and develops position coordinates. A communications module, remotely switchable between a standby mode and an active mode, is switched to the active mode by signals from a remote control station. A micro-controller is coupled to both modules and receives a control signal from the communications module when the communications module is active. The micro-controller controls the GPS module to switch to the active mode and develop position coordinates. The micro-controller receives the position coordinates and supplies them to the communications module. A power supply, the GPS module, the communications module, and the micro-controller are assembled in a unit designed to be small enough and compatible so as to be either implanted in an animal or secreted in an inanimate device.

### CROSS-REFERENCE TO RELATED APPLICATION

This application claims the benefit of U.S. Provisional Patent Application No. 61/338,743, filed Feb. 24, 2010.

### FIELD OF THE INVENTION

This invention relates to a GPS recovery system and more specifically to miniature GPS recovery units for use in finding or locating remote or lost items.

### BACKGROUND OF THE INVENTION

One of the major problems in the world today is the loss of items that are valuable and/or prized by the owner. The loss can occur through, for example, pets or prize animals wandering too far, misappropriation, or outright theft. The valuable or prized items that can be lost include pets or other animals, small portable devices that are easily carried, valuable art objects, etc. In many instances when any of these items run off or are mislaid it may take a great deal of time and effort to find them. In many instances if the items are misappropriated or stolen they may never be found.

At the present time the only known attempt to solve this problem is a system by which automobiles can be identified and found. However, as far as understood, the known system is only useful in finding automobiles and is not adaptable to items such as contemplated herein.

It would be highly advantageous, therefore, to remedy the foregoing and other deficiencies inherent in the prior art.

Accordingly, it is an object the present invention to provide a new and improved GPS recovery system including a miniature remote GPS unit and control assembly.

It is another object the present invention to provide a new and improved miniature remote GPS unit and control assembly miniaturized sufficiently to be installed or implanted into virtually any prized item.

It is another object the present invention to provide a new and improved miniature remote GPS unit and control assembly especially useful in identifying and locating any of a variety of animals and/or small portable devices.

### SUMMARY OF THE INVENTION

Briefly to achieve the desired objects of the present invention in accordance with a preferred embodiment thereof, provided is a miniature remote GPS unit and control assembly assembled in a unit designed to be either implanted in an animal or secreted in an inanimate device. The assembled unit includes a GPS module normally in an inactive mode and switchable between the inactive mode and an active mode. The GPS module is designed to receive signals in the active mode from GPS satellites and develop position coordinates in response to the signals. A communications module is remotely switchable between a standby mode and an active mode. The communications module is designed to receive signals from a remote control station and to switch from the standby mode to the active mode in response to an activation signal from the remote control station and to supply coordinates to the remote control station. A micro-controller is coupled to receive signals from and to supply signals to both the GPS module and the communications module. The micro-controller is designed and connected to receive a control signal from the communications module when the communications module is switched from the standby mode to the active mode. The micro-controller is designed and connected to control the GPS module to switch from the inactive mode to the active mode and to develop position coordinates. The micro-controller is further designed and connected to receive the position coordinates and supply the position coordinates to the communications module. A power supply is coupled to the GPS module, the communications module, and the micro-controller.

To further achieve the desired objects of the present invention in accordance with another embodiment thereof, a GPS recovery system includes a personal communications device, such as a cell phone or a lap top, including software designed to supply an activation signal and to receive coordinates of an item to be recovered. The GPS recovery system also includes a miniature remote GPS unit and control assembly including a GPS module normally in an inactive mode and switchable between the inactive mode and an active mode and designed to receive signals in the active mode from GPS satellites and develop position coordinates in response to the signals, a communications module remotely switchable between a standby mode and an active mode, and a micro-controller coupled to receive signals from and to supply signals to both the GPS module and the communications module. The micro-controller is designed and connected to receive a control signal from the communications module when the communications module is switched from the standby mode to the active mode, to control the GPS module to switch from the inactive mode to the active mode, and to receive the position coordinates from the GPS module and supply the position coordinates to the communications module. A power supply is coupled to the GPS module, the communications module, and the micro-controller. The miniature remote GPS unit and control assembly are assembled in a unit and positioned in the item to be recovered. A remote control station is designed to communicate with the personal communications device and the miniature remote GPS unit and control assembly. The remote control station is designed to supply signals to the communications module in response to reception of the activation signal from the personal communications device to switch the communications module from the standby mode to the active mode and to receive the coordinates from the communications module and to supply the coordinates to the personal communications device in response to reception of the activation signal from the personal communications device.

To further achieve the desired objects of the present invention in accordance with a method thereof, a method of locating or positioning an item includes the step of providing a personal communications device including software designed to supply an activation signal and to receive coordinates of the item. The method further includes the step of providing a miniature remote GPS unit and control assembly assembled in a unit. The assembled unit includes a GPS module normally in an inactive mode and switchable between the inactive mode and an active mode. The GPS module is designed to receive signals in the active mode from GPS satellites and develop coordinates representative of position of the item in response to the signals. The assembled unit further includes a communications module remotely switchable between a standby mode and an active mode and a micro-controller coupled to receive signals from and to supply signals to both the GPS module and the communications module. The micro-controller is designed and connected to receive a control signal from the communications module when the communications module is switched from the standby mode to the active mode, to control the GPS module to switch from the inactive mode to the active mode, and to receive the position coordinates from the GPS module and supply the position coordinates to the communications module. A power supply is coupled to the GPS module, the communications module, and the micro-controller and the miniature remote GPS unit and control assembly is positioned in the item. The method further includes the step of providing a remote control station and designing the remote control station to communicate with the personal communications device and the miniature remote GPS unit and control assembly, designing the remote control station to supply signals to the communications module in response to reception of the activation signal from the personal communications device to switch the communications module from the standby mode to the active mode, and designing the remote control station to receive the coordinates from the communications module and to supply the coordinates to the personal communications device in response to reception of the activation signal from the personal communications device.

### BRIEF DESCRIPTION OF THE DRAWINGS

Specific objects and advantages of the invention will become readily apparent to those skilled in the art from the following detailed description of a preferred embodiment thereof, taken in conjunction with the drawings in which:

FIG. 1 is a flow chart illustrating operation of the GPS recovery system, including a miniature remote GPS unit and control assembly, in accordance with the present invention;

FIG. 2 is a simplified block diagram of the GPS recovery system according to the present invention;

FIG. 3 is a simplified flow chart in accordance with the present invention;

FIG. 4 is a block diagram of the miniature remote GPS unit and control assembly of FIG. 1;

FIGS. 5A and 5B illustrate a schematic diagram of one embodiment of the miniature remote GPS unit and control assembly of FIG. 4; and

FIG. 6 illustrates connections and placement for the components of the schematic diagram of FIGS. 5A and 5B.

### DETAILED DESCRIPTION OF A PREFERRED EMBODIMENT

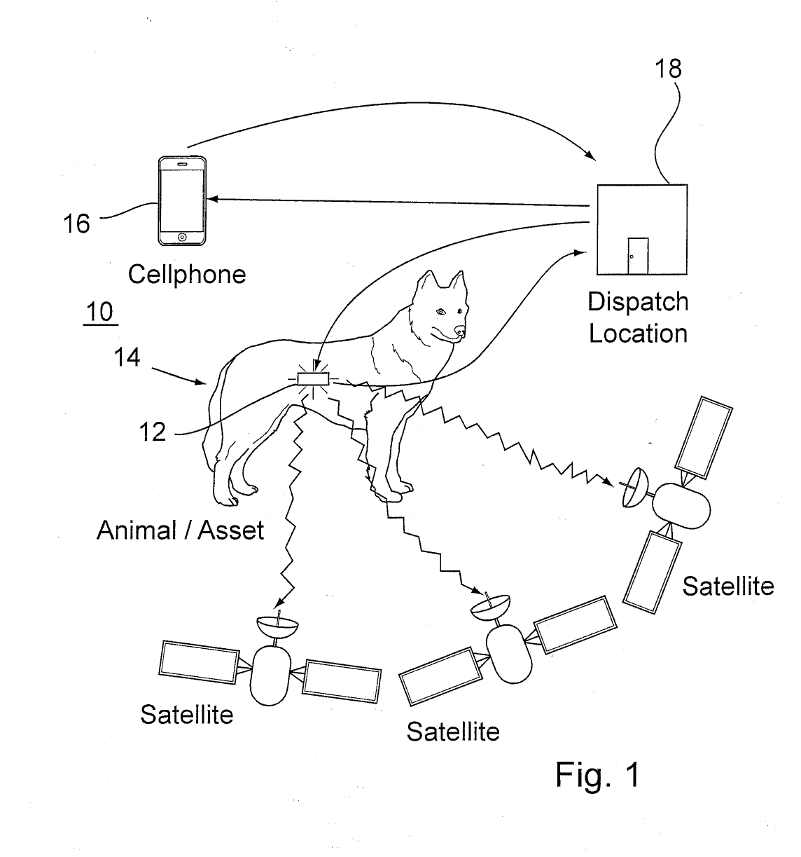

Referring specifically to FIG. 1, a flow chart is illustrated depicting operation of the present GPS recovery system, generally designated 10, in accordance with the present invention. System 10 includes a miniature remote GPS unit and control assembly 12 positioned within a prized animal or other prized item, hereinafter “item” designated 14. In accordance with and as a component of system 10, the owner or custodian of item 14 has a cell phone or other communication device, designated 16. When the owner or custodian wishes to locate item 14 they simply communicate with a dispatch location 18 using an identifying code, generally identifying both the owner and the item. Dispatch location 18 then contacts a control module of remote GPS unit and control assembly 12. Assembly 12 is normally in a sleep mode to save the battery and contacting assembly 12 activates the remote GPS unit, which establishes the coordinates of its position or location from three or more satellites in the GPS positioning system. A control module of assembly 12 sends the GPS coordinates to dispatch location 18 and, in the preferred embodiment, dispatch location 18 converts the coordinates to a visual map with item 14 marked thereon and sends the map to communication device 16. To simplify the explanation the “coordinates” are sent or received throughout this disclosure but it will be understood that signals representative of the coordinates are actually sent. When the process is completed assembly 12 is returned to the sleep mode.

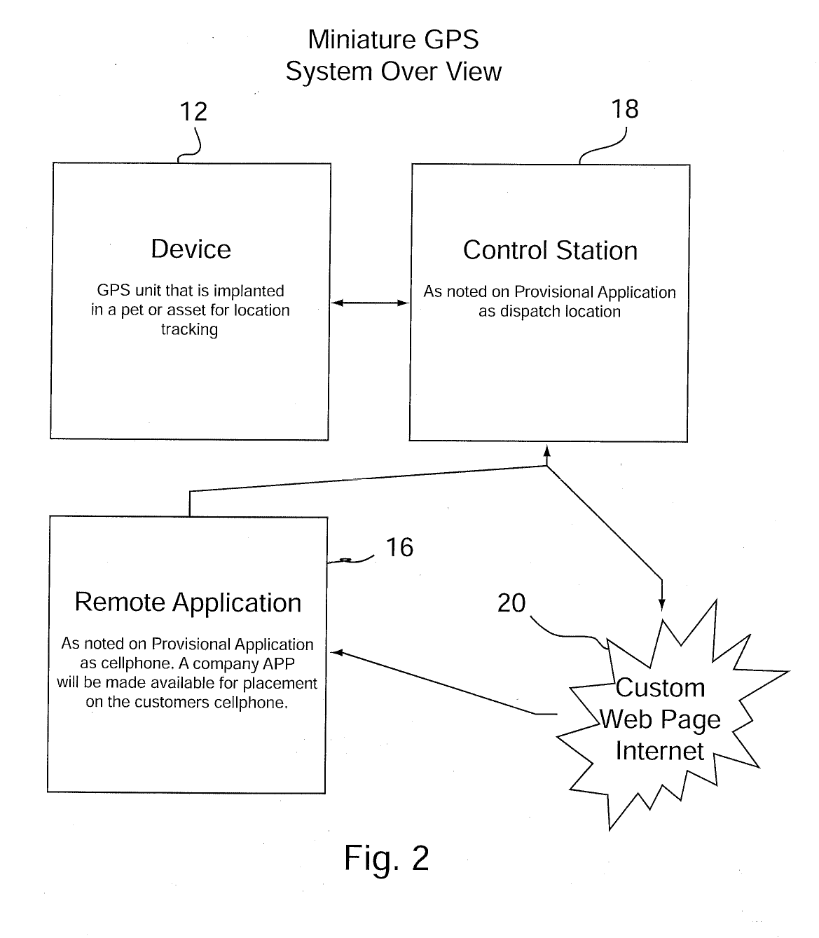

Referring additionally to FIG. 2, a simplified block diagram of GPS recovery system 10 is illustrated. Device 12 is a GPS unit that is miniaturized to the point it can be implanted in a prized animal or secreted in a prized item. Dispatch location 18 is a control station that can communicate with device 12 and, in this preferred embodiment, a custom web page, designated 20, on the internet. Cell phone or other communication device 16 is capable of communicating with control station 18 and receiving information from custom web page 20. In this preferred embodiment communication device 16 is supplied with an APP that is made available by the licensing or issuing company for placement on device 16. The customer or owner of device 16 simply logs onto the company web site to track device 12.

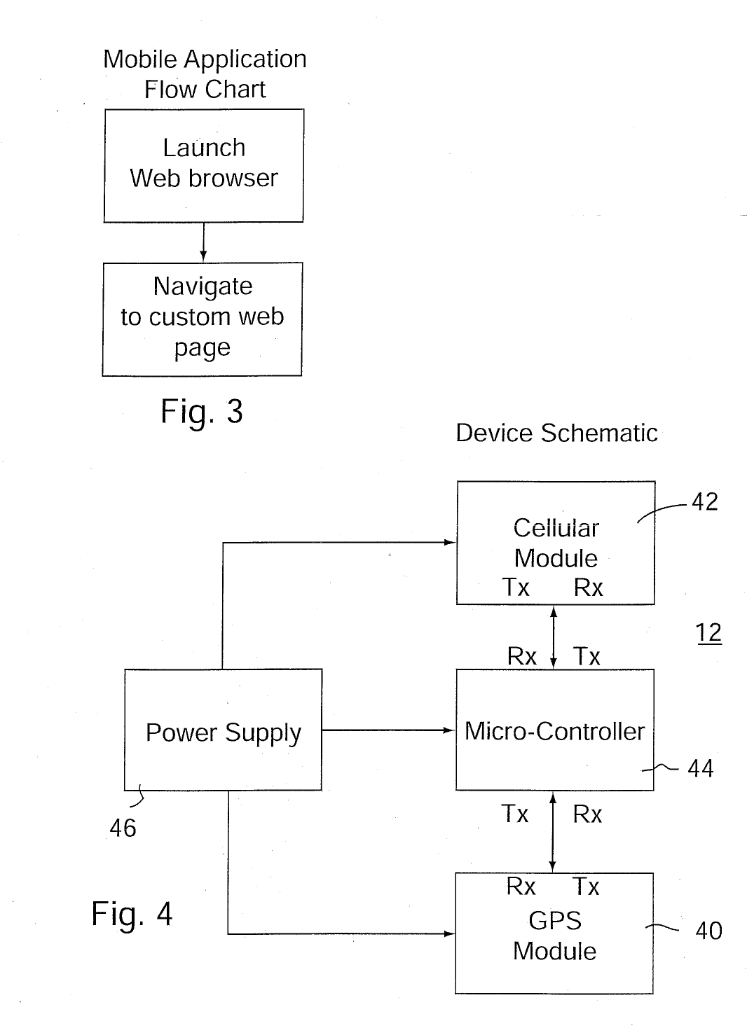

Turning additionally to FIG. 3, a mobile flow chart is illustrated, which explains in more detail the APP described in conjunction with FIG. 2. As indicated, device 12 with the company APP installed includes an embedded web browser. No user controls are included. Upon launch, the web browser navigates to a unique web page, located on the company server and the location of item 14 is displayed on, for example, a “Google Maps” map. It should be understood that different implementations may be used for each mobile platform (device 16) the company supports. For example, the process is different between a Windows laptop and a Droid smart phone.

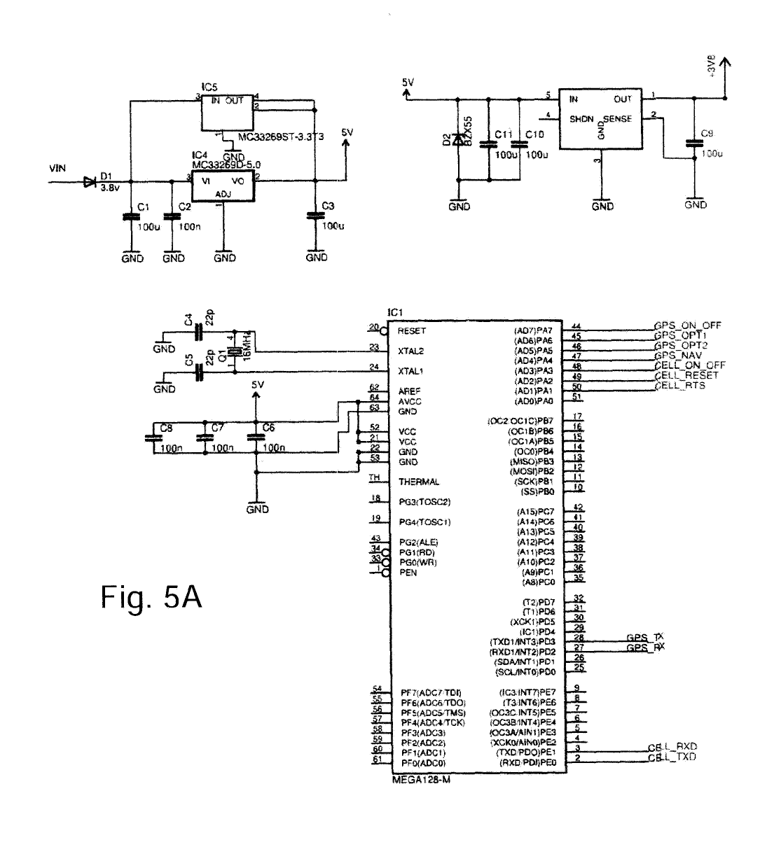

Referring now to FIG. 4, a block diagram is illustrated of miniature remote GPS unit and control assembly 12 in accordance with the present invention. Assembly 12 includes a GPS module 40, a cellular module 42, a micro-controller 44 and a power supply 46, such as a battery or the like. The components are interconnected so that when cellular module 42 receives a signal it signals micro-controller 44 to activate GPS module 40. GPS module 40 then receives coordinates of its position or location and sends the coordinates through micro-controller 44 to cellular module 42. Cellular module 42 is in a stand-by mode to conserve battery life. GPS module 40 is deactivated at all times until called upon by micro-controller 44. When the GPS coordinates are determined and sent to micro-controller 44 micro-controller 44 returns GPS module 40 to the stand-by or deactivated mode.

Assembly 12 is a self-contained encapsulated assembly in which GPS module 40 and control module 42 are each about the size of a baby's fingernail and the entire assembly 12 is about the size of the U.S. coin known as a quarter, i.e. less than approximately one inch in diameter if round and across a diagonal if rectangular. Further, in this preferred embodiment assembly 12 is encapsulated in a biocompatible epoxy resin or the like (same as a pacemaker), which will not irritate any tissue when implanted into an animal.

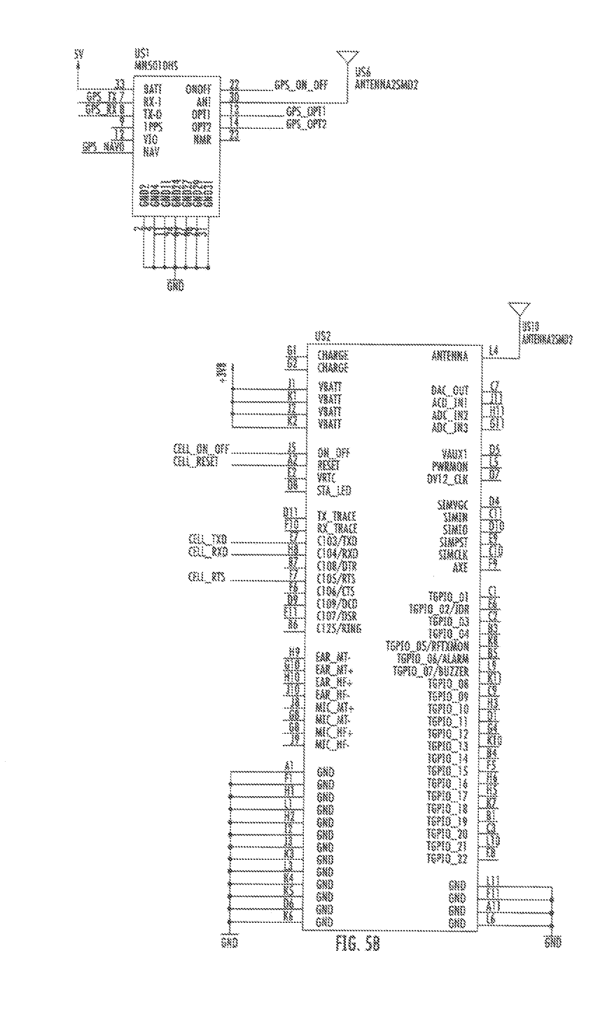

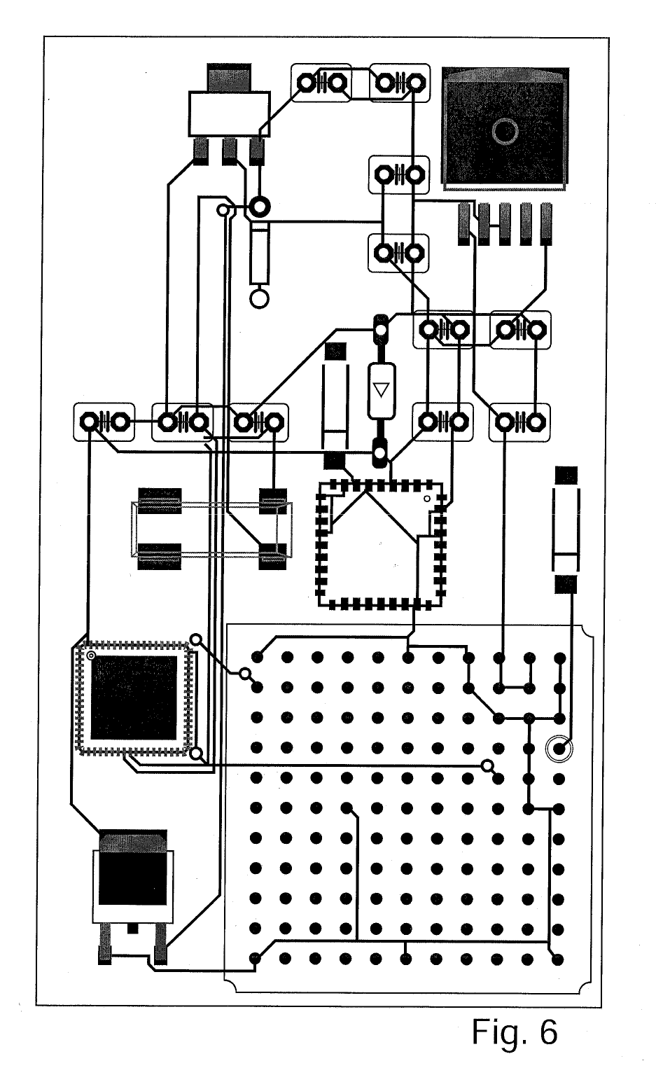

Referring additionally to FIGS. 5A and 5B, a schematic diagram of one embodiment of miniature remote GPS unit and control assembly 12 is illustrated, with components that can be used to provide the functions described. Also, a wiring and position diagram is illustrated in FIG. 6 depicting one arrangement for a rectangularly shaped mother board. It will be understood that other components and wiring arrangements and configurations may be devised but the embodiment illustrated comes within the concept of being miniaturized sufficiently to be installed or implanted into virtually any prized item.

Thus a GPS recovery system including a miniature remote GPS unit and control assembly is disclosed. The miniature remote GPS unit and control assembly is a self-contained encapsulated assembly that is sufficiently miniaturized to be installed or implanted into virtually any prized item. Also, the miniature remote GPS unit and control assembly is or can be encapsulated in a biocompatible material which will not irritate any tissue when implanted into an animal.

Various changes and modifications to the embodiments herein chosen for purposes of illustration will readily occur to those skilled in the art. To the extent that such modifications and variations do not depart from the spirit of the invention, they are intended to be included within the scope thereof which is assessed only by a fair interpretation of the following claims.

Having fully described the invention in such clear and concise terms as to enable those skilled in the art to understand and practice the same, the invention claimed is:

1. A miniature remote GPS unit and control assembly comprising:
a GPS module normally in an inactive mode and switchable between the inactive mode and an active mode, the GPS module being designed to receive signals in the active mode from GPS satellites and develop position coordinates in response to the signals;
a communications module remotely switchable between a standby mode and an active mode, the communications module being designed to receive signals from a remote control station and to switch from the standby mode to the active mode in response to an activation signal from the remote control station and to supply coordinates to the remote control station;
a micro-controller coupled to receive signals from and to supply signals to both the GPS module and the communications module, the micro-controller being designed and connected to receive a control signal from the communications module when the communications module is switched from the standby mode to the active mode, the micro-controller being designed and connected to control the GPS module to switch from the inactive mode to the active mode and to develop position coordinates, the micro-controller being designed and connected to receive the position coordinates and supply the position coordinates to the communications module;
a power supply coupled to the GPS module, the communications module, and the micro-controller; and
the power supply, the GPS module, the communications module, and the micro-controller being assembled in a unit designed to be one of implanted in an animal and secreted in an inanimate device.

2. A miniature remote GPS unit and control assembly as claimed in claim 1 wherein the unit is designed to be implanted in an animal.

3. A miniature remote GPS unit and control assembly as claimed in claim 2 wherein the unit is encapsulated in a biocompatible material which will not irritate any tissue when implanted.

4. A miniature remote GPS unit and control assembly as claimed in claim 3 wherein the biocompatible material is an epoxy resin.

5. A GPS recovery system comprising:
a personal communications device including software designed to supply an activation signal and to receive coordinates of an item to be recovered;
a miniature remote GPS unit and control assembly including:
a GPS module normally in an inactive mode and switchable between the inactive mode and an active mode, the GPS module being designed to receive signals in the active mode from GPS satellites and develop position coordinates in response to the signals;
a communications module remotely switchable between a standby mode and an active mode;
a micro-controller coupled to receive signals from and to supply signals to both the GPS module and the communications module, the micro-controller being designed and connected to receive a control signal from the communications module when the communications module is switched from the standby mode to the active mode, the micro-controller being designed and connected to control the GPS module to switch from the inactive mode to the active mode, the micro-controller being designed and connected to receive the position coordinates from the GPS module and supply the position coordinates to the communications module;
a power supply coupled to the GPS module, the communications module, and the micro-controller; and
the miniature remote GPS unit and control assembly being assembled in a unit and positioned in the item to be recovered; and
a remote control station designed to communicate with the personal communications device and the miniature remote GPS unit and control assembly, the remote control station being designed to supply signals to the communications module in response to reception of the activation signal from the personal communications device to switch the communications module from the standby mode to the active mode, and the remote control station being designed to receive the coordinates from the communications module and to supply the coordinates to the personal communications device in response to reception of the activation signal from the personal communications device.

6. A GPS recovery system as claimed in claim 5 wherein the personal communications device includes a display capable of illustrating the position of the item on a map in response to receiving the coordinates from the remote control station.

7. A GPS recovery system as claimed in claim 6 wherein the personal communications device includes a cell phone

8. A GPS recovery system as claimed in claim 7 wherein the software designed to supply an activation signal and to receive signals representative of coordinates of an item installed in the cell phone are included as an APP.

9. A GPS recovery system as claimed in claim 5 wherein the miniature remote GPS unit and control assembly is designed to be implanted in an animal.

10. A GPS recovery system as claimed in claim 9 wherein the miniature remote GPS unit and control assembly is encapsulated in a biocompatible material which will not irritate any tissue when implanted.

11. A GPS recovery system as claimed in claim 10 wherein the biocompatible material is an epoxy resin.

12. A method of locating or positioning an item comprising the steps of:
providing a personal communications device including software designed to supply an activation signal and to receive coordinates defining the location or position of the item;
providing a miniature remote GPS unit and control assembly assembled in a unit and including:
a GPS module normally in an inactive mode and switchable between the inactive mode and an active mode, the GPS module being designed to receive signals in the active mode from GPS satellites and develop coordinates defining the position of the item in response to the signals;
a communications module remotely switchable between a standby mode and an active mode;
a micro-controller coupled to receive signals from and to supply signals to both the GPS module and the communications module, the micro-controller being designed and connected to receive a control signal from the communications module when the communications module is switched from the standby mode to the active mode, the micro-controller being designed and connected to control the GPS module to switch from the inactive mode to the active mode, the micro-controller being designed and connected to receive the position coordinates from the GPS module and supply the position coordinates to the communications module; and
a power supply coupled to the GPS module, the communications module, and the micro-controller;
positioning the assembled miniature remote GPS unit and control assembly in the item; and
providing a remote control station and designing the remote control station to communicate with the personal communications device and the miniature remote GPS unit and control assembly, designing the remote control station to supply signals to the communications module in response to reception of the activation signal from the personal communications device to switch the communications module from the standby mode to the active mode, and designing the remote control station to receive the coordinates from the communications module and to supply the coordinates to the personal communications device in response to reception of the activation signal from the personal communications device.

13. A method as claimed in claim 12 wherein the step of providing the personal communications device includes providing a device including a display capable of illustrating the position of the item on a map in response to receiving the coordinates from the remote control station.

14. A method as claimed in claim 13 wherein the step of providing the personal communications device includes providing a cell phone

15. A method as claimed in claim 14 wherein the step of providing the personal communications device including software designed to supply an activation signal and to receive signals representative of coordinates of an item includes installing the software in the cell phone as an APP.

16. A method as claimed in claim 12 wherein the step of positioning the miniature remote GPS unit and control assembly in the item includes implanting the miniature remote GPS unit and control assembly in an animal.

17. A method as claimed in claim 16 wherein the step of implanting includes encapsulating the miniature remote GPS unit and control assembly in a biocompatible material which will not irritate any tissue when implanted.

18. A method as claimed in claim 17 wherein the step of encapsulating includes encapsulating in a biocompatible epoxy resin.
